(19) United States
(12) Patent Application Publication
(10) Pub. No.: US 2026/0352375 A1
(43) Pub. Date: Nov. 5, 2026

(54) COMMUNICATION SYSTEM WITH A REDUNDANT ASYNCHRONOUS POINT-TO-POINT LINK ARCHITECTURE TO FACILITATE UNINTERRUPTED SINGLE EVENT FUNCTIONAL INTERRUPT RECOVERY

(71) Applicant: The Boeing Company, Arlington, VA (US)

(72) Inventors: Tuan QUACH, San Clemente, CA (US); Willis HOANG, Los Angeles, CA (US); David LARUE, Torrance, CA (US)

(21) Appl. No.: 19/198,510

(22) Filed: May 5, 2025

(51) Int. Cl. H04L 1/08

(52) U.S. Cl. CPC H04L 1/08

(57) ABSTRACT

A communication system includes a first device that includes a first controller, a second device that includes a second controller, and a first asynchronous point-to-point link and a second asynchronous point-to-point link that connect the first device and the second device. The first controller is configured to generate a data frame that includes a sequence identifier in a header of the data frame, store a first copy of the data frame in a first transmission data structure of the first device to cause the first copy of the data frame to be transmitted to the second device via the first asynchronous point-to-point link, and store a second copy of the data frame in a second transmission data structure of the first device to cause the second copy of the data frame to be transmitted to the second device via the second asynchronous point-to-point link.

### FIELD

The present disclosure relates generally to a communication system, and to a communication system with a redundant asynchronous point-to-point link architecture to facilitate uninterrupted single event functional interrupt recovery.

### BACKGROUND

A single event functional interrupt (SEFI) is a type of error caused by ionizing radiation. A radiation-induced particle strikes an electronic component, which disrupts a normal operation of the electronic component.

### SUMMARY

An embodiment of the present disclosure provides a communication system, comprising: a first device that includes a first controller; a second device that includes a second controller; and a first asynchronous point-to-point link and a second asynchronous point-to-point link that connect the first device and the second device, wherein the first controller is configured to: generate a data frame that includes a sequence identifier in a header of the data frame; store a first copy of the data frame in a first transmission data structure of the first device to cause the first copy of the data frame to be transmitted to the second device via the first asynchronous point-to-point link; and store a second copy of the data frame in a second transmission data structure of the first device to cause the second copy of the data frame to be transmitted to the second device via the second asynchronous point-to-point link.

Another embodiment of the present disclosure provides a device, comprising: a first asynchronous point-to-point port; a second asynchronous point-to-point port; and a controller configured to: generate a data frame that includes a sequence identifier in a header of the data frame; cause a first copy of the data frame to be transmitted to another device via the first asynchronous point-to-point port; and cause a second copy of the data frame to be transmitted to the other device via the second asynchronous point-to-point port.

Yet a further embodiment of the present disclosure provides a device, comprising: a first asynchronous point-to-point port; a second asynchronous point-to-point port; and a controller configured to: obtain, via the first asynchronous point-to-point port and from another device, a first copy of a data frame that includes a sequence identifier; determine, based on the sequence identifier included in the first copy of the data frame, that a data frame that includes the sequence identifier has not been previously received by the device; accept the first copy of the data frame for further processing by the controller based on determining that a data frame that includes the sequence identifier has not been previously received by the device; obtain, via the second asynchronous point-to-point port and from the other device, a second copy of the data frame that includes the sequence identifier; determine, based on the sequence identifier included in the second copy of the data frame and based on accepting the first copy of the data frame for further processing, that a data frame that includes the sequence identifier has been previously received by the device; and reject the second copy of the data frame for further processing by the controller based on determining that a data frame that includes the sequence identifier has been previously received by the device.

The features, functions, and advantages described herein can be achieved independently in various implementations or can be combined in other implementations, further details of which are shown in the drawings and described below.

### BRIEF DESCRIPTION OF THE DRAWINGS

FIG. 1 is a diagram of an example implementation associated with a communication system with a redundant asynchronous point-to-point link architecture to facilitate uninterrupted SEFI recovery.

FIGS. 2A-2C are diagrams of an example implementation associated with a communication system with a redundant asynchronous point-to-point link architecture to facilitate uninterrupted SEFI recovery.

FIGS. 3A-3B are diagrams of an example implementation associated with a communication system with a redundant asynchronous point-to-point link architecture to facilitate uninterrupted SEFI recovery.

FIGS. 4A-4D are diagrams of an example implementation associated with a communication system with a redundant asynchronous point-to-point link architecture to facilitate uninterrupted SEFI recovery.

FIG. 5 is a diagram of an example data frame associated with a communication system with a redundant asynchronous point-to-point link architecture to facilitate uninterrupted SEFI recovery.

FIG. 6 is a diagram of example components of a device associated with a communication system with a redundant asynchronous point-to-point link architecture to facilitate uninterrupted SEFI recovery.

FIG. 7 is a flowchart of an example process associated with a communication system with a redundant asynchronous point-to-point link architecture to facilitate uninterrupted SEFI recovery.

FIG. 8 is a flowchart of an example process associated with a communication system with a redundant asynchronous point-to-point link architecture to facilitate uninterrupted SEFI recovery.

FIG. 9 is a flowchart of an example process associated with communication system with a redundant asynchronous point-to-point link architecture to facilitate uninterrupted SEFI recovery.

### DETAILED DESCRIPTION

The following detailed description of example implementations refers to the accompanying drawings. The same reference numbers in different drawings identify the same or similar elements.

In a communication system that comprises multiple interconnected devices, such as a satellite with devices performing distinct functionalities, two or more devices are often directly connected in order to share information. For example, a pair of devices may be connected in order to exchange asynchronous packetized data, such as to coordinate operations, relay sensor data, or manage system health. However, when such a system operates in harsh environments, such as outer space, where exposure to high levels of radiation is common, critical electronic components are susceptible to errors such as SEFIs. These radiation-induced events can disrupt normal operation and, specifically, degrade or inhibit the ability of two devices to communicate reliably.

To mitigate such faults, each device in the communication system can be configured to detect communication failures or internal errors and trigger reset procedures aimed at restoring functionality. These reset procedures may target specific components involved in inter-device communication, such as interface ports, transceivers, or protocol controllers. Such a reset procedure is often referred to as a SEFI recovery. However, initiating a reset procedure temporarily ceases communication between connected devices while affected components are reinitialized. During this period, critical data exchange is halted, which may delay or interrupt the devices'ability to execute configured tasks. As a result, a reset procedure, though necessary for recovery, can negatively impact an overall performance, responsiveness, and reliability of the communication system, especially with respect to mission-critical applications where continuous operation is required.

Some implementations described herein include a communications system that comprises a first device and a second device. The first device includes a first asynchronous point-to-point port that is connected to a first asynchronous point-to-point port of the second device via a first asynchronous point-to-point link. Further, the first device includes a second asynchronous point-to-point port that is connected to a second asynchronous point-to-point port of the second device via a second asynchronous point-to-point link. In this way, the communication system has a redundant asynchronous point-to-point link architecture.

For example, the first device is configured to transmit respective copies of a data frame to the second device via the first asynchronous point-to-point link and the second asynchronous point-to-point link to improve a likelihood that the second device receives a copy of the data frame (even when some of the respective first ports or the second ports of the first device and the second device are affected by errors, such as SEFIs). In this way, a likelihood that communication between the first device and the second device being interrupted is reduced, which facilitates the devices'carrying out configured tasks without unnecessary delays or disruptions. This improves overall system reliability and performance, particularly in environments where uninterrupted operation is critical to mission success.

Additionally, in some implementations, the second device includes a controller that is configured to accept a selected one of a first copy of a data frame or a second copy of the data frame for further processing (e.g., by the controller) and to reject a non-selected one of the first copy of the data frame or the second copy of the data frame for further processing. For example, a sequence identifier can be included in the copies of the data frame (e.g., in headers of the copies of the data frame), which allows the controller to determine that the copies of the data frame are the same and that one copy is to be accepted and another rejected. In this way, even though the second device receives redundant copies of a data frame, the second device is configured to accept only a single copy of the data frame for further processing. This selective acceptance prevents duplication of effort and ensures that computing resources (e.g., processing resources, memory resources, communication resources, and/or power resources, among other examples) of the second device are used efficiently. As a result, the second device can process the copy of the data frame promptly and reliably, minimizing delays or disruptions to overall system operations.

Additionally, in some implementations, when the second port of the first device and/or the second link are associated with a reset procedure (e.g., to enable a recovery of the second port and/or the second link), a controller of the first device prevents transmission of copies of data frames via the second port and the second link. This conserves computing resources of the first device that would otherwise be used to generate and to transmit (or at least attempt to transmit) copies of data that cannot propagate to the second device.

Further, after the reset procedure has completed, the controller of the first device causes copies of data frames to transmit to the second device via the second port and the second link again. This allows the controller of the second device to obtain a copy of a particular data packet via the second port of the second device, often before the controller obtains another copy of the particular data packet via the first port of the second device (e.g., that was transmitted by the controller of the first device). The controller of the second device then pauses processing of the copy of the particular data packet until the controller obtains the other copy of the particular data packet (e.g., to allow “re-alignment” of data packets of the first link and the second link). This enables the controller of the second device to practice selective acceptance of a copy of the particular data packet, as described above.

In this way, the communication system described herein leverages a redundant asynchronous point-to-point link architecture to support continuous operation, even during a reset procedure (e.g., such as a SEFI recovery). By providing multiple independent communication paths between devices, the system ensures that if one link or port becomes temporarily unavailable due to a reset procedure initiated for recovery, an alternate link remains active.

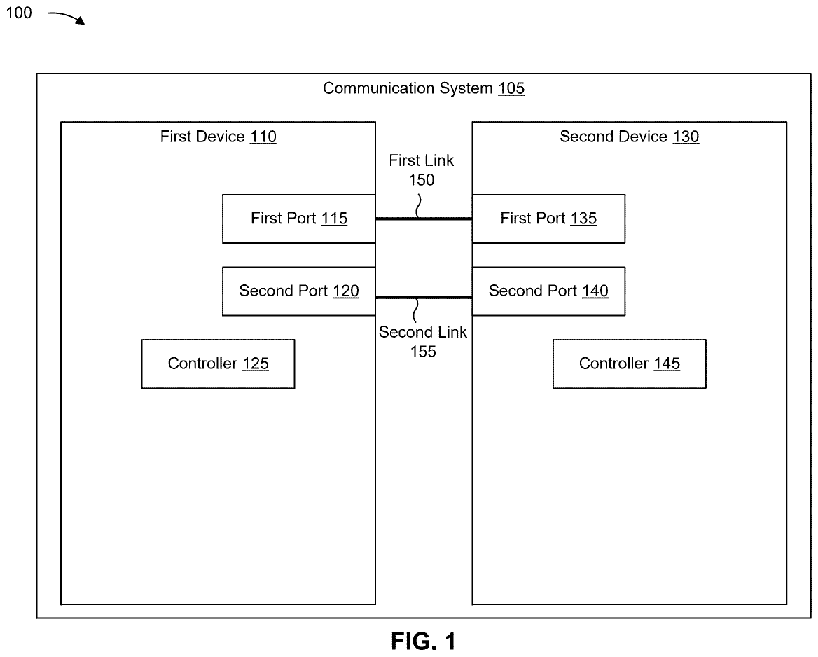

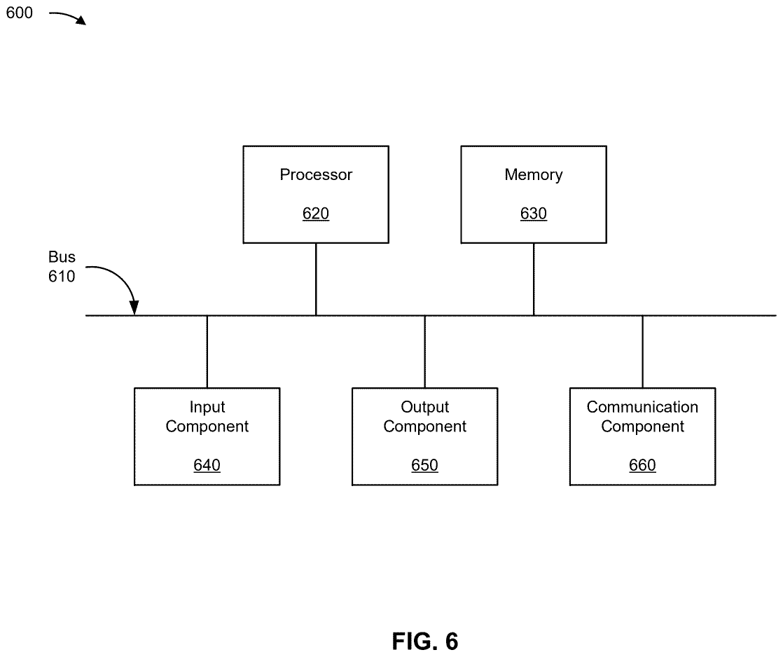

FIG. 1 is a diagram of an example implementation 100 associated with a communication system with a redundant asynchronous point-to-point link architecture to facilitate uninterrupted SEFI recovery. As shown in FIG. 1, example implementation 100 includes a communication system 105; a first device 110, which includes a first port 115, a second port 120, and a controller 125; and a second device 130, which includes a first port 135, a second port 140, and a controller 145. These devices are described in more detail below in connection with FIG. 6.

The communication system 105 may include one or more devices, such as the first device 110 and the second device 130, that are capable of receiving, generating, storing, processing, and/or providing information, as further described elsewhere herein. The communication system 105 may be a wireless communication device, such as a radio frequency (RF) device, a cellular network device, or another type of wireless communication device. In some implementations, the communication system 105 may be a non-terrestrial communication device, such as a low Earth orbit (LEO) satellite, a medium Earth orbit (MEO) satellite, a geostationary Earth orbit (GEO) satellite, a high elliptical orbit (HEO) satellite, or another type of satellite.

The first device 110 may include one or more devices capable of receiving, generating, storing, processing, and/or providing information, as described elsewhere herein. For example, the first device 110 may include a wireless communication device, a mobile phone, a user equipment, a laptop computer, a tablet computer, a desktop computer, or a similar type of device. In some implementations, the first device 110 includes RF components, cellular network components, satellite link components, or other types of wireless communication components.

The second device 130 may include one or more devices capable of receiving, generating, storing, processing, and/or providing information, as described elsewhere herein. For example, the second device 130 may include a wireless communication device, a mobile phone, a user equipment, a laptop computer, a tablet computer, a desktop computer, or a similar type of device. In some implementations, the second device 130 includes RF components, cellular network components, satellite link components, or other types of wireless communication components.

Each of the first port 115 and the second port 120, of the first device 110, is an asynchronous point-to-point port. For example, each of the first port 115 and the second port 120 may be configured to connect to another port (e.g., of another device) via an asynchronous point-to-point link, such as a serial gigabit media independent interface (SGMII) link. Additionally, each of the first port 135 and the second port 140, of the second device 130, is an asynchronous point-to-point port. For example, each of the first port 135 and the second port 140 may be configured to connect to another port (e.g., of another device) via an asynchronous point-to-point link, such as an SGMII link.

Accordingly, as shown in FIG. 1, example implementation 100 may include a first link 150 and a second link 155 that connect the first device 110 and the second device 130. For example, the first link 150 may connect the first device 110 and the second device 130 via the first port 115 of the first device 110 and the first port 135 of the second device 130. The second link 155 may connect the first device 110 and the second device 130 via the second port 120 of the first device 110 and the second port 140 of the second device 130.

Accordingly, the first link 150 and the second link 155 may each be a point-to-point link. For example, the first link 150 and the second link 155 may be SGMII links. In this way, because the first link 150 and the second link 155 both connect the first device 110 and the second device 130, the communication system 105 may be considered to have a redundant link architecture (e.g., a redundant asynchronous point-to-point link architecture).

The controller 125 is configured to control the first device 110. In some implementations, the controller 125 generates information that is to be provided to the second device 130 (e.g., to the controller 145 of the second device 130), such as via at least one of the first link 150 or the second link 155. For example, the controller 125 may generate a data frame and cause copies of the data frame to be transmitted to the second device 130 (e.g., to the controller 145 of the second device) via at least one of the first link 150 or the second link 155, as further described herein.

The controller 145 is configured to control the second device 130. In some implementations, the controller 145 obtains information that is transmitted to the second device 130 (e.g., from the controller 125 of the first device 110), such as via at least one of the first link 150 or the second link 155. For example, the controller 145 may obtain one or more copies of a data frame transmitted to the second device 130 (e.g., from the controller 125 of the first device 110) via at least one of the first link 150 or the second link 155, as further described herein. The controller 145 may then accept or reject a copy of a data frame for further processing by the controller 145, as further described herein.

While the first device 110 and the and the controller 125 are described herein as configured to generate and transmit information to the second device 130, and the second device 130 and the controller 145 are configured to obtain the information and thereby perform one or more actions, some implementations include other configurations. For example, the second device 130 and the controller 145 may be (further) configured to generate and transmit information to the first device 110, and the first device 110 and the controller 125 are (further) configured to obtain the information and thereby perform one or more actions.

As indicated above, FIG. 1 is provided as an example. Other examples may differ from what is described with regard to FIG. 1.

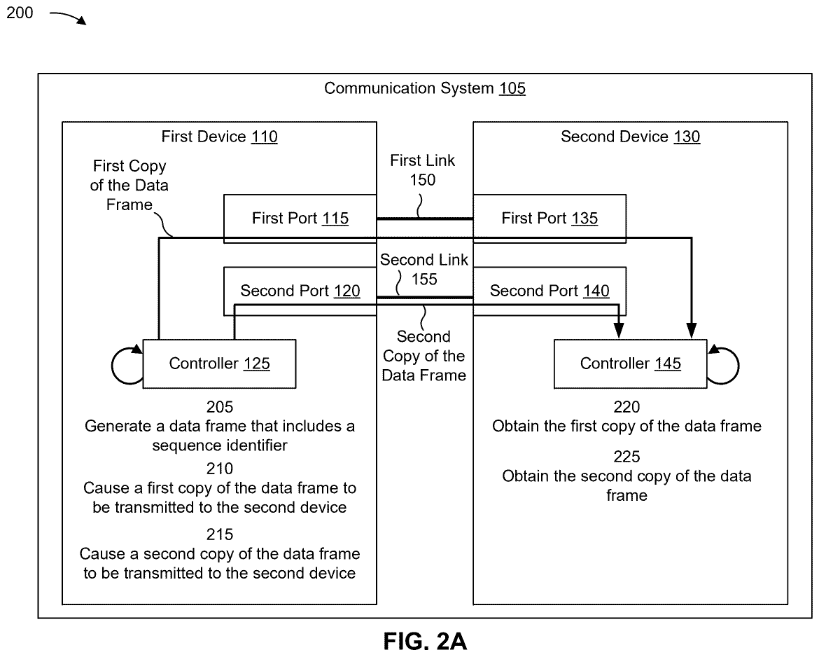

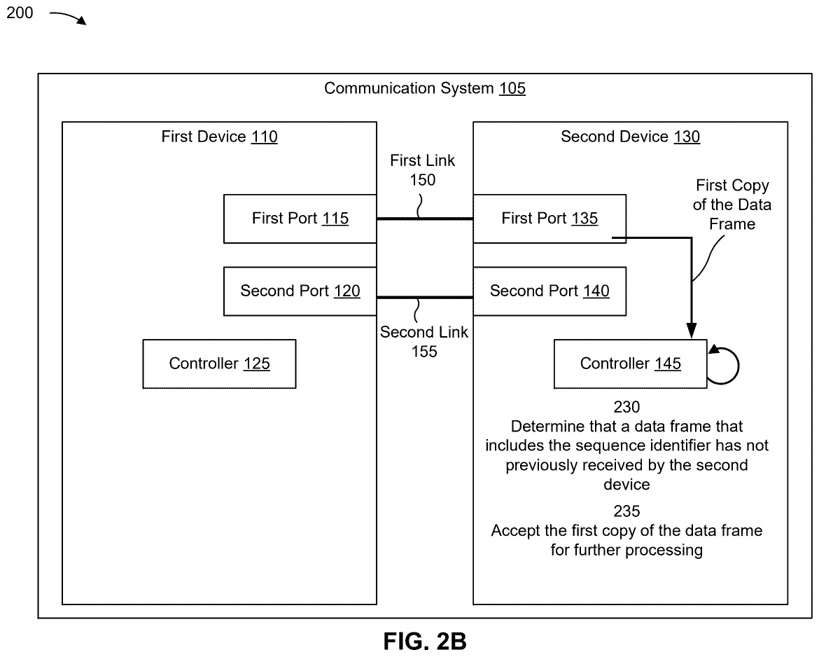

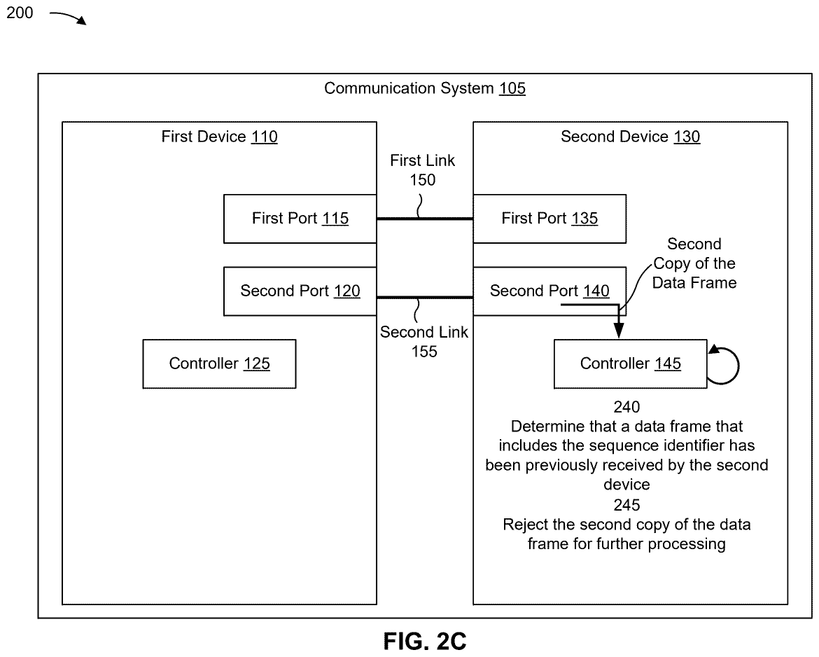

FIGS. 2A-2C are diagrams of an example implementation 200 associated with a communication system with a redundant asynchronous point-to-point link architecture to facilitate uninterrupted SEFI recovery. As shown in FIGS. 2A-2C, example implementation 200 includes the communication system 105, which includes the first device 110 and the second device 130, each of which are configured in a same or similar manner as that described herein in relation to FIG. 1.

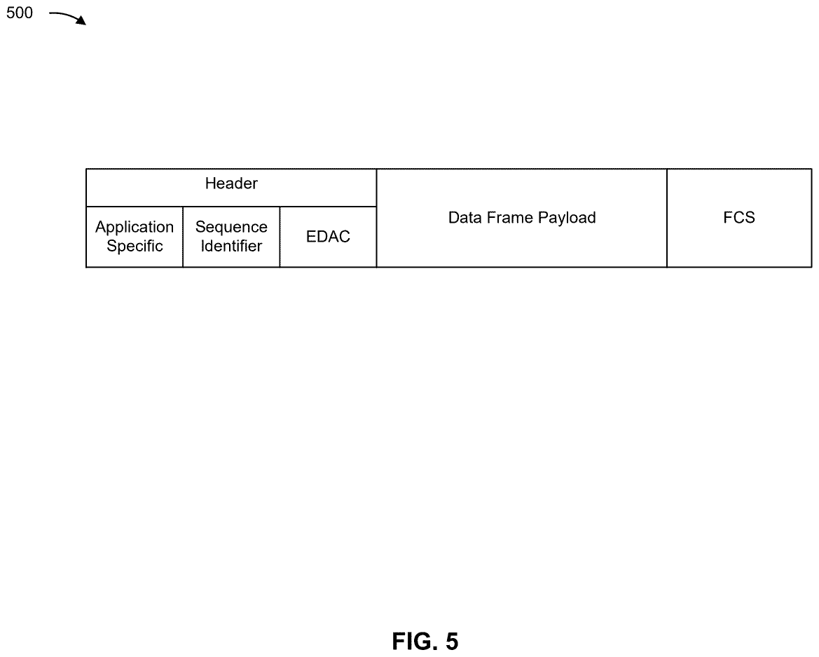

As shown in FIG. 2A, and by reference number 205, the controller 125 of the first device 110 is configured to generate a data frame. The data frame may be, for example, an Ethernet frame or another type of data frame (e.g., that is to be communicated via an asynchronous point-to-point port, such as the first port 115 or the second port 120, and/or an asynchronous point-to-point link, such as the first link 150 or the second link 155). As further indicated by reference number 205, the data frame includes a sequence identifier. The sequence identifier may be an alpha-numeric string, or another type of identifier, that identifies (e.g., uniquely identifies) the data frame. In some implementations, the sequence identifier may be included in a header of the data frame, as further described herein in relation to FIG. 5.

As shown by reference number 210, the controller 125 is configured to cause a first copy of the data frame to be transmitted to the second device 130 (e.g., to the controller 145 of the second device 130). For example, the controller 125 may be configured to store a first copy of the data frame in a first transmission data structure of the first device 110, such as a first transmission buffer (e.g., a first first-in-last-out (FIFO) transmission buffer), that is associated with the first port 115. This then may cause the first copy of the data frame to be transmitted to the second device 130 via the first port 115 and therefore via the first link 150. The first copy of the data frame may include the sequence identifier (e.g., in a header of the first copy of the data frame).

As shown by reference number 215, the controller 125 is configured to cause a second copy of the data frame to be transmitted to the second device 130 (e.g., to the controller 145 of the second device 130). For example, the controller 125 may be configured to store a second copy of the data frame in a second transmission data structure of the first device 110, such as a second transmission buffer (e.g., a second FIFO transmission buffer), that is associated with the second port 120. This then may cause the second copy of the data frame to be transmitted to the second device 130 via the second port 120 and therefore via the second link 155. The second copy of the data frame may include the sequence identifier (e.g., in a header of the second copy of the data frame).

As further shown in FIG. 2A, and by reference number 220, the controller 145 of the second device 130 is configured to obtain the first copy of the data frame (e.g., after transmission of the first copy of the data frame from the first device 110 via the first port 115 and the first link 150). For example, the second device 130 may receive the first copy of the data frame via the first port 135 of the second device 130, and may store the first copy of the data frame in a first reception data structure of the second device 130, such as a first reception buffer (e.g., a first FIFO reception buffer), that is associated with the first port 135. The controller 145 of the second device 130 then may obtain (e.g., retrieve) the first copy of the data frame from the first reception data structure.

As shown by reference number 225, the controller 145 of the second device 130 is configured to obtain the second copy of the data frame (e.g., after transmission of the second copy of the data frame from the first device 110 via the second port 120 and the second link 155). For example, the second device 130 may receive the second copy of the data frame via the second port 140 of the second device 130, and may store the second copy of the data frame in a second reception data structure of the second device 130, such as a second reception buffer (e.g., a second FIFO reception buffer), that is associated with the second port 140. The controller 145 of the second device 130 then may obtain (e.g., retrieve) the second copy of the data frame from the second reception data structure.

As shown in FIG. 2B, and by reference number 230, the controller 145 of the second device 130 may determine that a data frame (e.g., a copy of a data frame) that includes the sequence identifier (e.g., that is included in the first copy of the data frame and the second copy of the data frame) has not been previously received by the second device 130. For example, the controller 145 may obtain the first copy of the data frame before obtaining the second copy of the data frame (e.g., as described herein in relation to FIG. 2A and reference numbers 220 and 225). Accordingly, the controller 145 may process (e.g., read and/or parse) the first copy of data to identify the sequence identifier included in the first copy of the data frame (e.g., in the header of the first copy of the data frame). The controller 145 then may compare the sequence identifier and a value included in a sequence identifier tracking data structure of the second device 130 (e.g., that indicates one or more most recent sequence identifiers identified by the controller 145) to determine that a data frame that includes the sequence identifier has not been previously received by the second device 130.

Accordingly, as shown by reference number 235, the controller 145, based on determining that a data frame that includes the sequence identifier has not been previously received by the second device, may accept the first copy of the data frame for further processing (e.g., by the controller 145). This may include, for example, further processing of the first copy of the data frame to obtain and use information included in a payload of the first copy of the data frame.

Additionally, or alternatively, as shown in FIG. 2C, and by reference number 240, the controller 145 of the second device 130 may determine that a data frame (e.g., a copy of a data frame) that includes the sequence identifier (e.g., that is included in the first copy of the data frame and the second copy of the data frame) has been previously received by the second device 130. For example, the controller 145 may obtain the second copy of the data frame after obtaining the first copy of the data frame (e.g., as described herein in relation to FIG. 2A and reference numbers 220 and 225). Accordingly, the controller 145 may process (e.g., read and/or parse) the second copy of data to identify the sequence identifier included in the second copy of the data frame (e.g., in the header of the second copy of the data frame). The controller 145 then may compare the sequence identifier to a value included in a sequence identifier tracking data structure (e.g., that indicates one or more most recent sequence identifiers identified by the controller 145) to determine that a data frame (e.g., the first copy of the data frame) that includes the sequence identifier has been previously received by the second device 130.

Accordingly, as shown by reference number 245, the controller 145, based on determining that a data frame that includes the sequence identifier has been previously received by the second device, may reject the second copy of the data frame for further processing (e.g., by the controller 145). This may include, for example, dropping the second copy of the data frame, deleting the second copy of the data frame, or performing some other type of rejection operation.

As indicated above, FIGS. 2A-2C are provided as an example. Other examples may differ from what is described with regard to FIGS. 2A-2C.

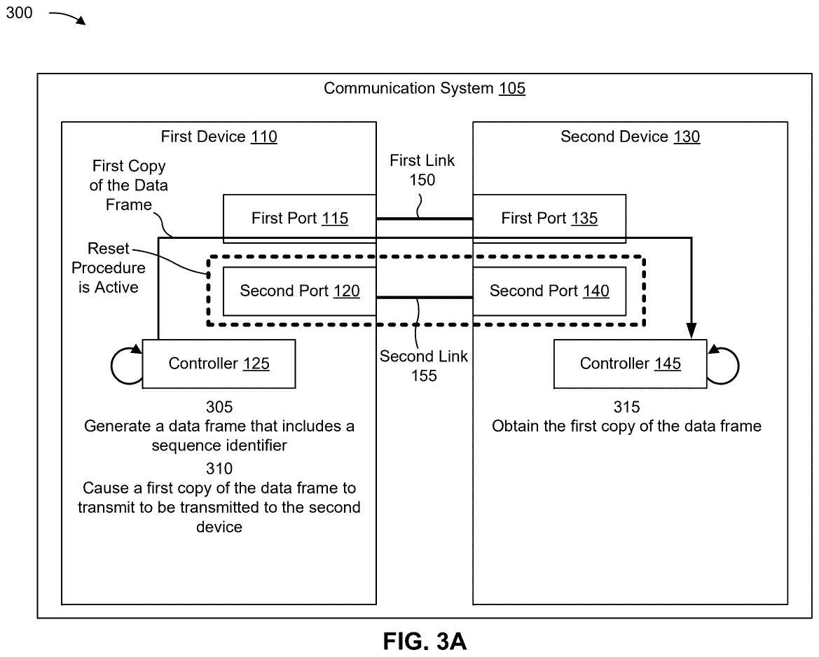

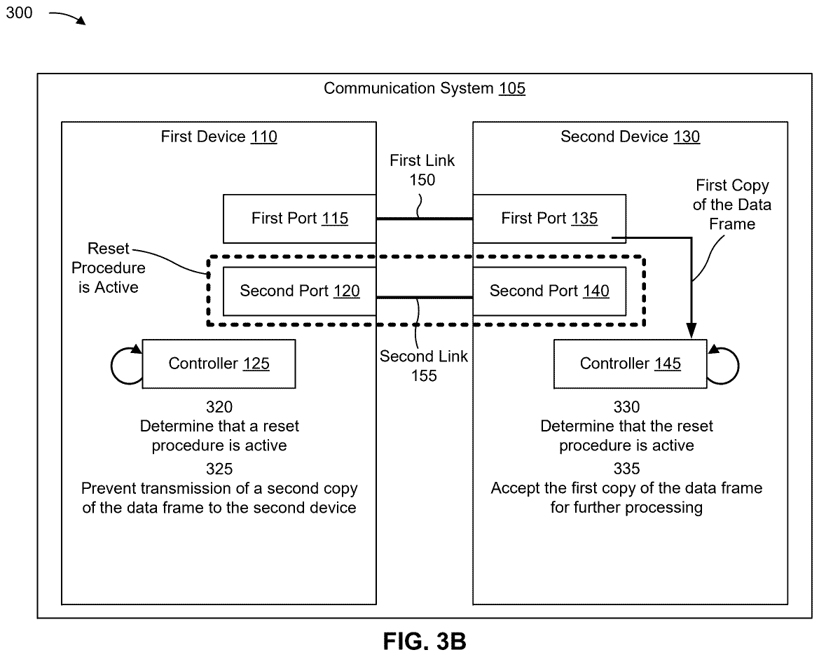

FIGS. 3A-3B are diagrams of an example implementation 300 associated with a communication system with a redundant asynchronous point-to-point link architecture to facilitate uninterrupted SEFI recovery. As shown in FIGS. 3A-3B, example implementation 300 includes the communication system 105, which includes the first device 110 and the second device 130, each of which are configured in a same or similar manner as that described herein in relation to FIGS. 1 and 2A-2C.

As shown in FIG. 3A, and by reference number 305, the controller 125 of the first device 110 is configured to generate a data frame, such as a data frame that includes a sequence identifier, in a same or similar manner as that described herein in relation to FIG. 2A and reference number 205. As shown by reference number 310, the controller 125 is configured to cause a first copy of the data frame to be transmitted to the second device 130, such as by storing the first copy of the data frame in a first transmission data structure of the first device 110, which may cause the first copy of the data frame to be transmitted to the second device 130 via the first port 115 and therefore via the first link 150, in a same or similar manner as that described herein in relation to FIG. 2A and reference number 210. As shown by reference number 315, the controller 145 of the second device 130 is configured to obtain the first copy of the data frame, such as from a first reception data structure of the second device 130 that is associated with the first port 135 of the second device 130, in a same or similar manner as that described herein in relation to FIG. 2A and reference number 220.

As shown in FIG. 3B, and by reference number 320, the controller 125 of the first device 110 is configured to determine that a reset procedure with the second port 120 and/or the second link 155 is active. For example, the controller 125 may determine (e.g., using an error detection technique) that the second port 120 and/or the second link 155 suffer from an error, such as a SEFI, and may therefore initiate a reset procedure for the second port 120 and/or the second link 155 (e.g., to facilitate recovery from the error). Accordingly, the controller 125 may determine that the reset procedure is active (e.g., based on initiating the reset procedure and based on determining that the reset procedure has not completed). As another example, the controller 125 may determine that the reset procedure is active based on status information associated with the second port 120 and/or the second link 155 (e.g., may determine that the reset procedure is active when the second port 120 and/or the second link 155 have non-active statuses).

As shown by reference number 325, the controller 125 of the first device 110 is configured to prevent transmission of a second copy of the data frame to the second device 130 (e.g., based on determining that the reset procedure is active). For example, the controller 125 may prevent storing of (or may abstain from storing) a second copy of the data frame in a second transmission structure of the first device 110, which prevents transmission of a second copy of the data frame to the second device via the second port 120 and the second link 155.

As further shown in FIG. 3B, and by reference number 330, the controller 145 of the second device 130 is configured to determine that the reset procedure with the second port 120 and/or the second link 155 is active. For example, the controller 145 may determine (e.g., using an error detection technique) that the second port 140 and/or the second link 155 suffer from an error, such as a SEFI, and may therefore initiate the reset procedure for the second port 140 and/or the second link 155 (e.g., to facilitate recovery from the error). Accordingly, the controller 145 may determine that the reset procedure is active (e.g., based on initiating the reset procedure and based on determining that the reset procedure has not completed). As another example, the controller 145 may determine that the reset procedure is active based on status information associated with the second port 140 and/or the second link 155 (e.g., may determine that the reset procedure is active when the second port 140 and/or the second link 155 have non-active statuses).

Accordingly, as shown by reference number 335, the controller 145, based on determining that the reset procedure is active, may accept the first copy of the data frame for further processing (e.g., by the controller 145). This may include, for example, further processing the first copy of the data frame to obtain and use information included in a payload of the first copy of the data frame. In this way, while the reset procedure is active, the controller 145 does not need to compare sequence identifiers included in first copies of data frames and values included in a sequence identifier tracking data structure of the second device 130 before accepting the first copies of the data frames, which conserves computing resources of the second device 130.

As indicated above, FIGS. 3A-3B are provided as an example. Other examples may differ from what is described with regard to FIGS. 3A-3B.

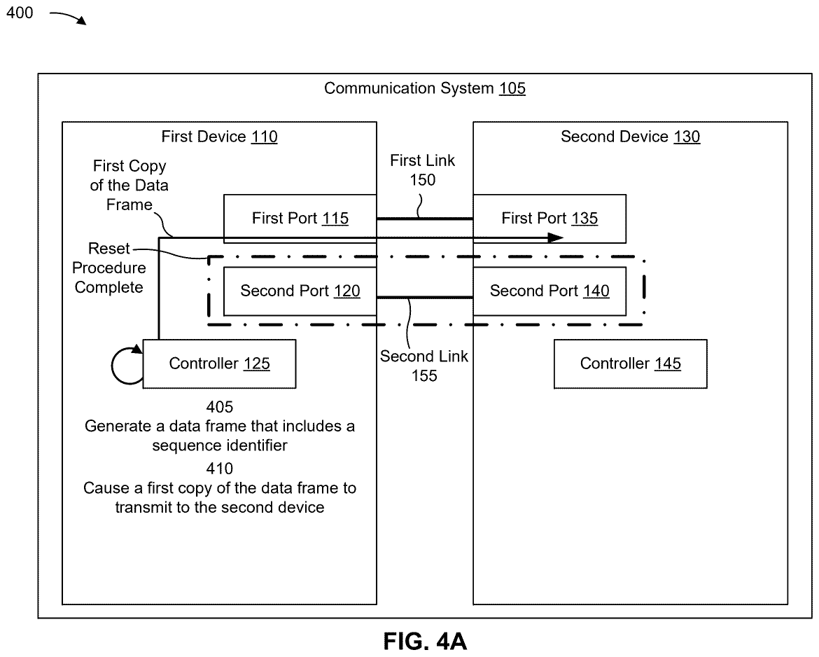

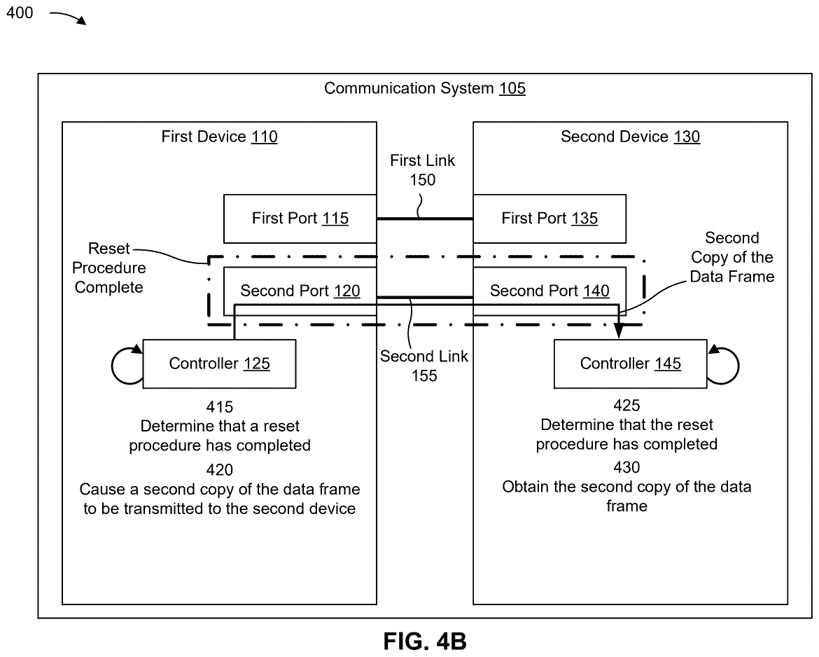

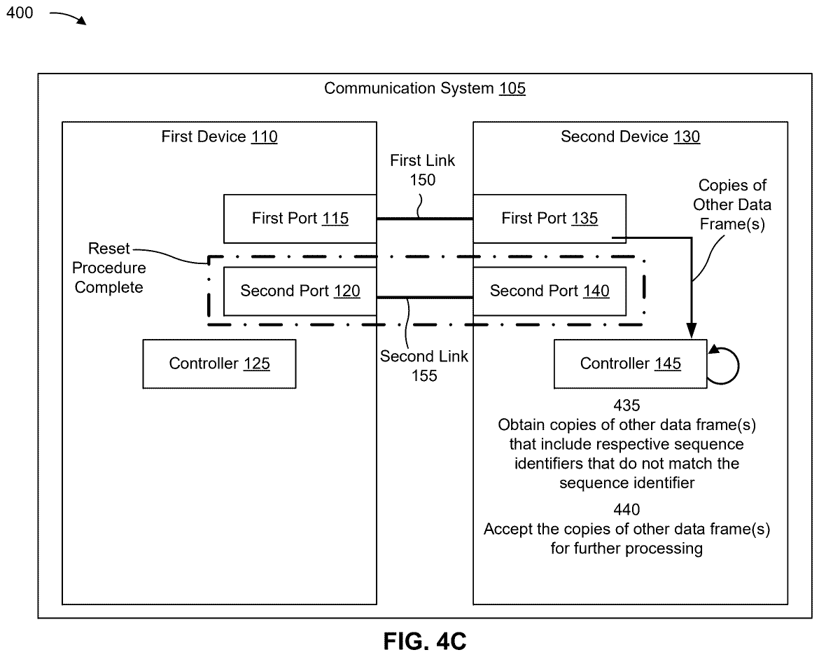

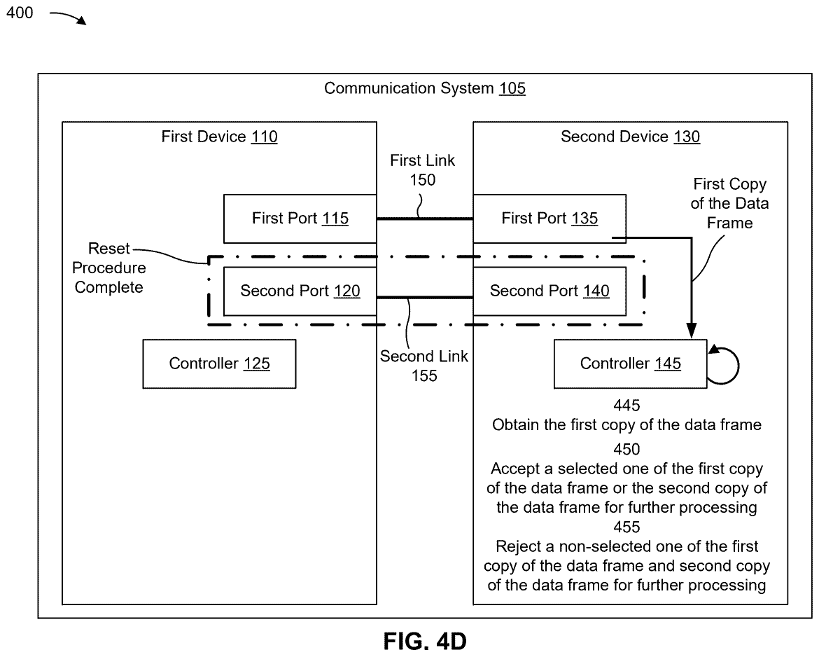

FIGS. 4A-4D are diagrams of an example implementation 400 associated with a communication system with a redundant asynchronous point-to-point link architecture to facilitate uninterrupted SEFI recovery. As shown in FIGS. 4A-4D, example implementation 400 includes the communication system 105, which includes the first device 110 and the second device 130, each of which are configured in a same or similar manner as that described herein in relation to FIGS. 1, 2A-2C, and 3A-3B. As further shown in FIG. 4A-4D, a reset procedure (e.g., as described herein in relation to FIGS. 3A-3B) associated with the second port 120 of the first device 110, the second port 140 of the second device 130, and/or the second link 155 is complete.

As shown in FIG. 4A, and by reference number 405, the controller 125 of the first device 110 is configured to generate a data frame, such as a data frame that includes a sequence identifier, in a same or similar manner as that described herein in relation to FIG. 2A and reference number 205. As shown by reference number 410, the controller 125 is configured to cause a first copy of the data frame to be transmitted to the second device 130, such as by storing the first copy of the data frame in a first transmission data structure of the first device 110, which may cause the first copy of the data frame to be transmitted to the second device 130 via the first port 115 and therefore via the first link 150, in a same or similar manner as that described herein in relation to FIG. 2A and reference number 210.

As shown in FIG. 4B, and by reference number 415, the controller 125 of the first device 110 is configured to determine that the reset procedure has completed. For example, the controller 125 may determine that the reset procedure is complete based on status information associated with the second port 120 and/or the second link 155 (e.g., may determine that the reset procedure has completed when the second port 120 and/or the second link 155 have active statuses).

Accordingly, as shown by reference number 420, the controller 125 is configured to cause a second copy of the data frame to be transmitted to the second device 130. For example, the controller 125 may store the second copy of the data frame in a second transmission data structure of the first device 110, which may cause the second copy of the data frame to be transmitted to the second device 130 via the second port 120 and therefore via the second link 155, in a same or similar manner as that described herein in relation to FIG. 2A and reference number 210.

As further shown in FIG. 4B, and by reference number 425, the controller 145 of the second device 130 is configured to determine that the reset procedure has completed. For example, the controller 145 may determine that the reset procedure is complete based on status information associated with the second port 140 and/or the second link 155 (e.g., may determine that the reset procedure has completed when the second port 140 and/or the second link 155 have active statuses).

As shown by reference number 430, the controller 145 of the second device 130 is configured to obtain the second copy of the data frame. For example, the controller 145 may obtain the second copy of the data frame from a second reception data structure of the second device 130 that is associated with the second port 140 of the second device 130, in a same or similar manner as that described herein in relation to FIG. 2A and reference number 225.

As shown in FIGS. 4A-4B, the first copy of the data frame may be transmitted to the second device 130 before the second copy of the data frame is transmitted to second device 130. Notably, the controller 145 may obtain the second copy of the data frame prior to obtaining the first copy of the data frame (as further described herein in relation to FIG. 4D). This may be because second copies of other data frames ceased to be transmitted to the second device 130 while the reset procedure was active, and therefore the second transmission data structure of the first device 110 and the second reception data structure of the second device 130 may be empty (or at least not full) when the reset procedure completes. This may allow the second copy of the data frame to spend less time in the second transmission structure and/or the second reception data structure, which allows the controller 145 to obtain the second copy of the data frame prior to obtaining the first copy of the data frame.

Accordingly, as shown in FIG. 4C, and by reference number 435, the controller 145 of the second device 130 is configured to obtain copies of one or more other data frames. The controller 125 may generate and cause the copies of the one or more other data frames to be transmitted to the second device 130 (e.g., before transmitting the first copy of the data frame to the second device 130). For example, the controller 125 may store the copies of the one or more other data frames in the first transmission data structure of the first device 110, which may cause the copies of the one or more other data frames to be transmitted to the second device 130 via the first port 115 and therefore via the first link 150, in a same or similar manner as that described herein in relation to FIG. 2A and reference number 205. The controller 145 of the second device 130 then may obtain the copies of the one or more other data frames from the first reception data structure of the second device 130 that is associated with the first port 135 of the second device 130, in a same or similar manner as that described herein in relation to FIG. 2A and reference number 220.

Notably, the copies of the one or more other data frames may include respective identifiers that do not match (e.g., are not equal to) the sequence identifier included in the second copy of the data frame. Accordingly, as shown by reference number 440, the controller 145 of the second device 130 is configured to accept the copies of the one or more other data frames for further processing (e.g., by the controller 145). For example, the controller 145 may compare the respective identifiers of the copies of the one or more other data frames to the sequence identifier included in the second copy of the data frame and, upon determining that there is no match, may accept the copies of the one or more other data frames for further processing.

As shown in FIG. 4D, and by reference number 445, the controller 145 of the second device 130 is configured to obtain the first copy of the data frame (e.g., after obtaining and accepting the copies of the one or more other data frames for further processing). For example, the second device 130 may receive the first copy of the data frame via the first port 135 of the second device 130, and may store the first copy of the data frame in the first reception data structure of the second device 130, which allows the controller 145 to retrieve the first copy of the data frame from the first reception data structure, in a same or similar manner as that described herein in relation to FIG. 2A and reference number 220.

In this way, the controller 145 obtains both the first copy of the data frame and the second copy of the data frame. The controller 145 then selects one of the first copy of the data frame and the second copy of the data frame. For example, the controller 145 may select the second copy of the data frame because the controller 145 obtained the second copy of the data frame before obtaining the first copy of the data frame. Alternatively, the controller 145 may select the first copy of the data frame because the controller 125 of the first device transmitted the first copy of the data frame before transmitting the second copy of the data frame.

As shown by reference number 450, the controller 145 of the second device 130 may accept the selected one of the first copy of the data frame or the second copy of the first other data frame for further processing (e.g., by the controller 145), in a same or similar manner as that described herein in relation to FIG. 2B and reference number 235. Additionally, or alternatively, as shown by reference number 455, the controller 145 may reject a non-selected one of the first copy of the first other data frame or the second copy of the first other data frame for further processing (e.g., by the controller 145), in a same or similar manner as that described herein in relation to FIG. 2C and reference number 245.

As indicated above, FIGS. 4A-4D are provided as an example. Other examples may differ from what is described with regard to FIGS. 4A-4D.

FIG. 5 is a diagram of an example data frame 500 associated with a communication system with a redundant asynchronous point-to-point link architecture to facilitate uninterrupted SEFI recovery. As shown in FIG. 5, the example data frame 500 includes a header, a data frame payload, and a frame check sequence (FCS). The header may include an application specification field (e.g., that includes one or more bits to facilitate communication of information for a specific applications), a sequence identifier field (e.g., that includes one or more bits to indicate a sequence identifier of the example data frame 500, as described elsewhere herein), and/or an error detection and correction (EDAC) field (e.g., that includes one or more bits to facilitate error detection and correction of the header of the example data frame 500). In some implementations, the example data frame 500 is an Ethernet frame and the header is a shim header.

As indicated above, FIG. 5 is provided as an example. Other examples may differ from what is described with regard to FIG. 5.

FIG. 6 is a diagram of example components of a device 600 associated with a communication system with a redundant asynchronous point-to-point link architecture to facilitate SEFI recovery. The device 600 corresponds to one or more of the communication system 105, the first device 110, the controller 125, the second device 130, and/or the controller 145. In some implementations, the communication system 105, the first device 110, the controller 125, the second device 130, and/or the controller 145 include one or more devices 600 and/or one or more components of the device 600. In the example shown in FIG. 6, the device 600 includes a bus 610, a processor 620, a memory 630, an input component 640, an output component 650, and/or a communication component 660.

The bus 610 includes one or more components that enable wired and/or wireless communication among the components of the device 600. The bus 610 couples together two or more components of FIG. 6, such as via operative coupling, communicative coupling, electronic coupling, and/or electric coupling. For example, the bus 610 may include an electrical connection (e.g., a wire, a trace, and/or a lead) and/or a wireless bus. The processor 620 includes a central processing unit, a graphics processing unit, a microprocessor, a controller, a microcontroller, a digital signal processor, a field-programmable gate array, an application-specific integrated circuit, and/or another type of processing component. The processor 620 may be implemented in hardware, firmware, or a combination of hardware and software. In some implementations, the processor 620 includes one or more processors capable of being programmed to perform one or more operations or processes described elsewhere herein.

The memory 630 includes volatile and/or nonvolatile memory, such as random access memory (RAM), read only memory (ROM), a hard disk drive, and/or another type of memory (e.g., a flash memory, a magnetic memory, and/or an optical memory). The memory 630 may include internal memory (e.g., RAM, ROM, or a hard disk drive) and/or removable memory (e.g., removable via a universal serial bus connection). In some implementations, the memory 630 is a non-transitory computer-readable medium. The memory 630 stores information, one or more instructions, and/or software (e.g., one or more software applications) related to the operation of the device 600. In some implementations, the memory 630 includes one or more memories that are coupled (e.g., communicatively coupled) to one or more processors (e.g., processor 620), such as via the bus 610. Communicative coupling between a processor 620 and a memory 630 enables the processor 620 to read and/or process information stored in the memory 630 and/or to store information in the memory 630.

The input component 640 enables the device 600 to receive input, such as user input and/or sensed input. For example, the input component 640 may include a touch screen, a keyboard, a keypad, a mouse, a button, a microphone, a switch, a sensor, a global positioning system sensor, a global navigation satellite system sensor, an accelerometer, a gyroscope, and/or an actuator. The output component 650 enables the device 600 to provide output, such as via a display, a speaker, and/or a light-emitting diode. The communication component 660 enables the device 600 to communicate with other devices via a wired connection and/or a wireless connection. For example, the communication component 660 may include a receiver, a transmitter, a transceiver, a modem, a network interface card, and/or an antenna.

In some implementations, the device 600 performs one or more operations or processes described herein. For example, a non-transitory computer-readable medium (e.g., memory 630) may store a set of instructions (e.g., one or more instructions or code) for execution by the processor 620. The processor 620 may execute the set of instructions to perform one or more operations or processes described herein. In some implementations, execution of the set of instructions, by one or more processors 620, causes the one or more processors 620 and/or the device 600 to perform one or more operations or processes described herein. In some implementations, hardwired circuitry is used instead of or in combination with the instructions to perform one or more operations or processes described herein. Additionally, or alternatively, the processor 620 may be configured to perform one or more operations or processes described herein. Thus, implementations described herein are not limited to any specific combination of hardware circuitry and software.

The number and arrangement of components shown in FIG. 6 are provided as an example. The device 600 may include additional components, fewer components, different components, or differently arranged components than those shown in FIG. 6. Additionally, or alternatively, a set of components (e.g., one or more components) of the device 600 may perform one or more functions described as being performed by another set of components of the device 600.

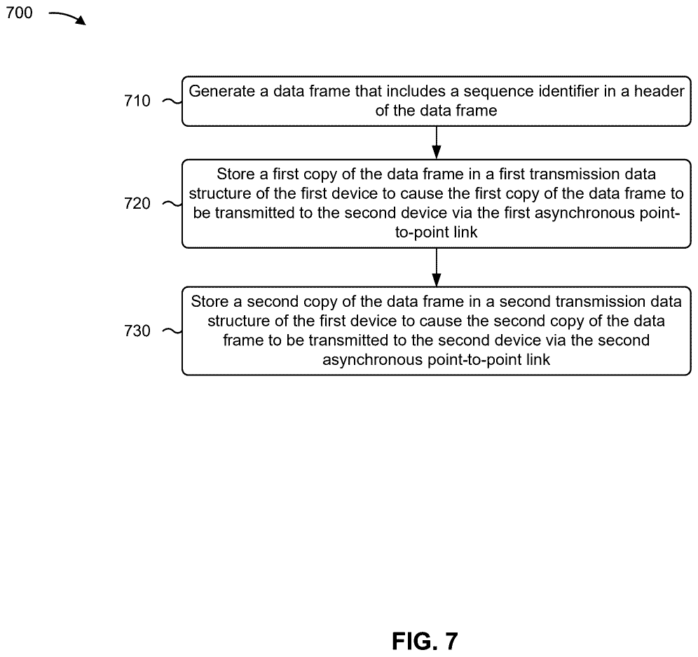

FIG. 7 is a flowchart of an example process 700 associated with a communication system with a redundant asynchronous point-to-point link architecture to facilitate uninterrupted SEFI recovery. One or more process blocks of FIG. 7 are performed by a first controller (e.g., the controller 125) of a first device (e.g., the first device 110) of a communication system (e.g., the communication system 105) and/or by another device or a group of devices of the first device. Additionally, or alternatively, one or more process blocks of FIG. 7 may be performed by one or more components of device 600, such as processor 620, memory 630, input component 640, output component 650, and/or communication component 660. The communication system further comprises a second device (e.g., the second device 130) that includes a second controller (e.g., the controller 145), and a first asynchronous point-to-point link and a second asynchronous point-to-point link that connect the first device and the second device.

As shown in FIG. 7, process 700 includes generating a data frame that includes a sequence identifier in a header of the data frame (block 710). For example, the first controller may generate a data frame that includes a sequence identifier in a header of the data frame, as described above.

As further shown in FIG. 7, process 700 includes storing a first copy of the data frame in a first transmission data structure of the first device to cause the first copy of the data frame to be transmitted to the second device via the first asynchronous point-to-point link (block 720). For example, the first controller may store a first copy of the data frame in a first transmission data structure of the first device to cause the first copy of the data frame to be transmitted to the second device via the first asynchronous point-to-point link, as described above.

As further shown in FIG. 7, process 700 includes storing a second copy of the data frame in a second transmission data structure of the second device to cause the second copy of the data frame to be transmitted to the second device via the second asynchronous point-to-point link (block 730). For example, the second controller may store a second copy of the data frame in a second transmission data structure of the second device to cause the second copy of the data frame to be transmitted to the second device via the second asynchronous point-to-point link, as described above.

Process 700 may include additional aspects, such as any single aspect or any combination of aspects described below and/or in connection with one or more other processes described elsewhere herein.

In a first aspect, the first asynchronous point-to-point link and the second asynchronous point-to-point link are SGMII links, and the data frame is an Ethernet frame.

In a second aspect, alone or in combination with the first aspect, the first copy of the data frame includes the sequence identifier, and process 700 includes the second controller obtaining, after transmission of the first copy of the data frame via the first asynchronous point-to-point link, the first copy of the data frame from a first reception data structure of the second device; determining, based on identifying the sequence identifier included in the first copy of the data frame, that a data frame that includes the sequence identifier has not been previously received by the second device; and accepting the first copy of the data frame for further processing by the second controller based on determining that a data frame that includes the sequence identifier has not been previously received by the second device.

In a third aspect, alone or in combination with one or more of the first and second aspects, the second copy of the data frame includes the sequence identifier, and process 700 includes the second controller obtaining, after transmission of the second copy of the data frame via the second asynchronous point-to-point link, the second copy of the data frame from a second reception data structure of the second device; determining, based on identifying the sequence identifier included in the second copy of the data frame, that a data frame that includes the sequence identifier has been previously received by the second device; and rejecting the second copy of the data frame for further processing by the second controller based on determining that a data frame that includes the sequence identifier has been previously received by the second device.

In a fourth aspect, alone or in combination with one or more of the first through third aspects, process 700 includes generating a first other data frame that includes a first other sequence identifier in a header of the first other data frame, storing a copy of the first other data frame in the first transmission data structure of the first device to cause the first copy of the first other data frame to be transmitted to the second device via the first asynchronous point-to-point link, determining that a reset procedure associated with the second asynchronous point-to-point link is active, and preventing, based on determining that the reset procedure is active, storing of a second copy of the first other data frame in the second transmission data structure of the first device.

In a fifth aspect, alone or in combination with one or more of the first through fourth aspects, process 700 includes generating a second other data frame that includes a second other sequence identifier in a header of the second other data frame, storing a first copy of the second other data frame in the first transmission data structure of the first device to cause the first copy of the second other data frame to be transmitted to the second device via the first asynchronous point-to-point link, determining that the reset procedure associated with the second asynchronous point-to-point link has completed, and storing, based on determining that the reset procedure has completed, a second copy of the second other data frame in the second transmission data structure of the first device to cause the first copy of the second other data frame to be transmitted to the second device via the second asynchronous point-to-point link.

In a sixth aspect, alone or in combination with one or more of the first through fifth aspects, process 700 includes the second controller obtaining, after transmission of the first copy of the data frame via the first asynchronous point-to-point link, the first copy of the data frame from a first reception data structure of the second device; determining that a reset procedure associated with the second asynchronous point-to-point link is active; and accepting the first copy of the data frame for further processing by the second controller based on determining that the reset procedure is active.

In a seventh aspect, alone or in combination with one or more of the first through sixth aspects, process 700 includes the second controller determining that the reset procedure associated with the second asynchronous point-to-point link has completed; obtaining, based on determining that the reset procedure has completed, a copy of a first other data frame from a second reception data structure of the second device; obtaining, based on identifying another sequence identifier included in the copy of the first other data frame, copies of one or more second other data frames from the first reception data structure of the second device that include respective sequence identifiers that do not match the other sequence identifier; and accepting the copies of one or more second other data frames for further processing by the second controller.

In an eighth aspect, alone or in combination with one or more of the first through seventh aspects, the copy of the first other data frame is a first copy of the first other data frame, and process 700 includes the second controller obtaining, after accepting the copies of one or more second other data frames for further processing by the second controller, a second copy of the first other data frame from the first reception data structure of the second device; accepting a selected one of the first copy of the first other data frame or the second copy of the first other data frame for further processing by the second controller; and rejecting a non-selected one of the first copy of the first other data frame or the second copy of the first other data frame for further processing by the second controller.

In a ninth aspect, alone or in combination with one or more of the first through eighth aspects, the communication system is one of a low Earth orbit satellite, a medium Earth orbit satellite, a geostationary orbit satellite, or a highly elliptical orbit satellite.

Although FIG. 7 shows example blocks of process 700, in some implementations, process 700 includes additional blocks, fewer blocks, different blocks, or differently arranged blocks than those depicted in FIG. 7. Additionally, or alternatively, two or more of the blocks of process 700 may be performed in parallel.

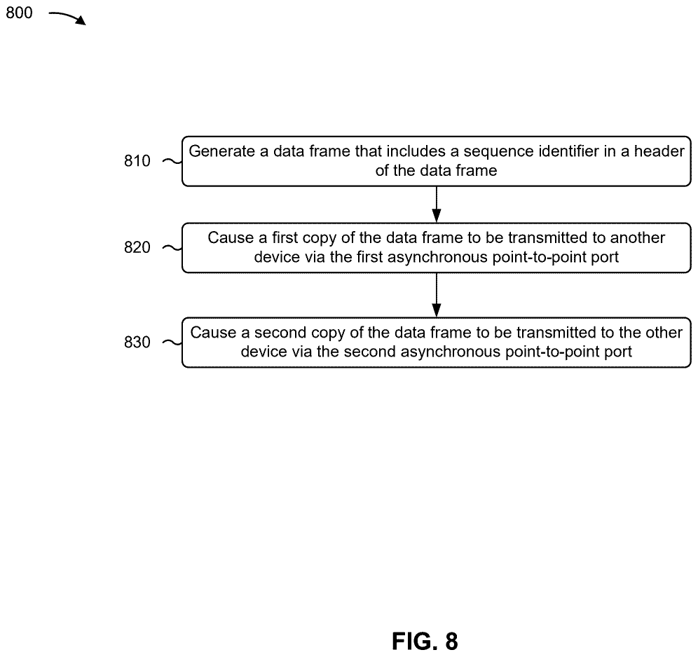

FIG. 8 is a flowchart of an example process 800 associated with a communication system with a redundant asynchronous point-to-point link architecture to facilitate uninterrupted SEFI recovery. One or more process blocks of FIG. 8 are performed by a first controller (e.g., the controller 125) of a device (e.g., the first device 110) and/or by another device or a group of devices of the device. Additionally, or alternatively, one or more process blocks of FIG. 8 may be performed by one or more components of device 600, such as processor 620, memory 630, input component 640, output component 650, and/or communication component 660. The device further comprises a first asynchronous point-to-point port and a second asynchronous point-to-point link port.

As shown in FIG. 8, process 800 includes generating a data frame that includes a sequence identifier in a header of the data frame (block 810). For example, the controller may generate a data frame that includes a sequence identifier in a header of the data frame, as described above.

As further shown in FIG. 8, process 800 includes causing a first copy of the data frame to be transmitted to another device via the first asynchronous point-to-point port (block 820). For example, the controller may cause a first copy of the data frame to be transmitted to another device via the first asynchronous point-to-point port, as described above.

As further shown in FIG. 8, process 800 includes causing a second copy of the data frame to be transmitted to another device via the second asynchronous point-to-point port (block 830). For example, the controller may cause a second copy of the data frame to be transmitted to the other device via the second asynchronous point-to-point port, as described above.

In a first aspect, process 800 includes generating a first other data frame that includes a first other sequence identifier in a header of the first other data frame, causing a copy of the first other data frame to be transmitted to the other device via the first asynchronous point-to-point port, determining that a reset procedure associated with the second asynchronous point-to-point port is active, and preventing, based on determining that the reset procedure is active, transmission of a second copy of the first other data frame to the other device via the second asynchronous point-to-point port.

In a second aspect, alone or in combination with the first aspect, process 800 includes generating a second other data frame that includes a second other sequence identifier in a header of the second other data frame; causing a first copy of the second other data frame to be transmitted to the other device via the first asynchronous point-to-point port; determining that the reset procedure associated with the second asynchronous point-to-point port has completed; and causing a second copy of the second other data frame to be transmitted to the other device via the second asynchronous point-to-point port.

In a third aspect, alone or in combination with one or more of the first and second aspects, process 800 includes obtaining, via the first asynchronous point-to-point port and from the other device, a copy of another data frame; determining that a reset procedure associated with the second asynchronous point-to-point port is active; and accepting the copy of the other data frame for further processing by the controller based on determining that the reset procedure is active.

In a fourth aspect, alone or in combination with one or more of the first through third aspects, process 800 includes determining that a reset procedure associated with the second asynchronous point-to-point port has completed; obtaining, based on determining that the reset procedure has completed, via the second asynchronous point-to-point port, and from the other device, a copy of a first other data frame that includes another sequence identifier; obtaining, based on determining that the reset procedure has completed, via the first asynchronous point-to-point port, and from the other device, copies of one or more second other data frames that include respective sequence identifiers that do not match the other sequence identifier; and accepting the copies of the one or more second other data frames for further processing by the controller.

Although FIG. 8 shows example blocks of process 800, in some implementations, process 800 includes additional blocks, fewer blocks, different blocks, or differently arranged blocks than those depicted in FIG. 8. Additionally, or alternatively, two or more of the blocks of process 800 may be performed in parallel.

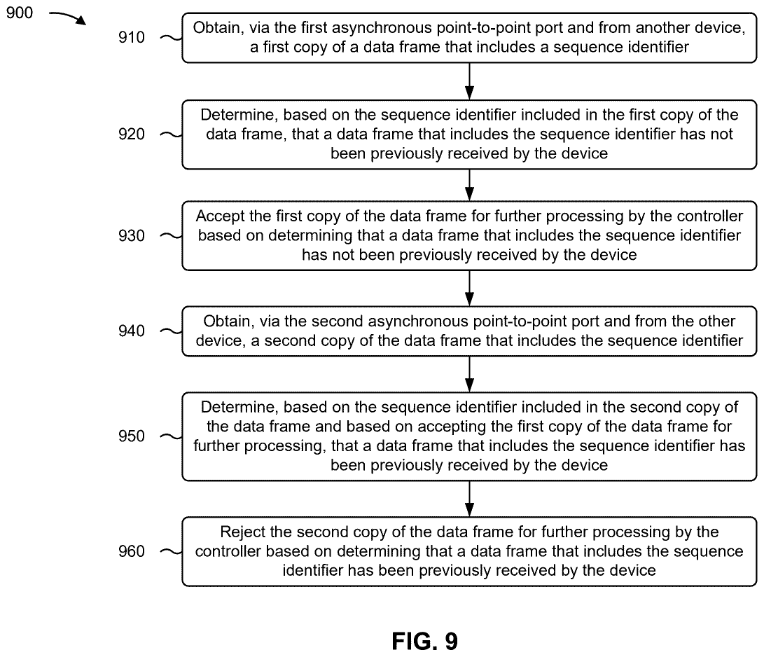

FIG. 9 is a flowchart of an example process 900 associated with communication system with a redundant asynchronous point-to-point link architecture to facilitate uninterrupted SEFI recovery. One or more process blocks of FIG. 9 are performed by a controller (e.g., the controller 145) of a device (e.g., the second device 130) and/or by another device or a group of devices separate from or including the device. Additionally, or alternatively, one or more process blocks of FIG. 9 may be performed by one or more components of device 600, such as processor 620, memory 630, input component 640, output component 650, and/or communication component 660. The device further comprises a first asynchronous point-to-point port and a second asynchronous point-to-point link port.

As shown in FIG. 9, process 900 includes obtaining, via the first asynchronous point-to-point port and from another device, a first copy of a data frame that includes a sequence identifier (block 910). For example, the controller may obtain, via the first asynchronous point-to-point port and from another device, a first copy of a data frame that includes a sequence identifier, as described above.

As further shown in FIG. 9, process 900 includes determining, based on the sequence identifier included in the first copy of the data frame, that a data frame that includes the sequence identifier has not been previously received by the device (block 920). For example, the controller may determine, based on the sequence identifier included in the first copy of the data frame, that a data frame that includes the sequence identifier has not been previously received by the device, as described above.

As further shown in FIG. 9, process 900 includes accepting the first copy of the data frame for further processing by the controller based on determining that a data frame that includes the sequence identifier has not been previously received by the device (block 930). For example, the controller may accept the first copy of the data frame for further processing by the controller based on determining that a data frame that includes the sequence identifier has not been previously received by the device, as described above.

As further shown in FIG. 9, process 900 includes obtaining, via the second asynchronous point-to-point port and from the other device, a second copy of the data frame that includes the sequence identifier (block 940). For example, the controller may obtain, via the second asynchronous point-to-point port and from the other device, a second copy of the data frame that includes the sequence identifier, as described above.

As further shown in FIG. 9, process 900 includes determining, based on the sequence identifier included in the second copy of the data frame and based on accepting the first copy of the data frame for further processing, that a data frame that includes the sequence identifier has been previously received by the device (block 950). For example, the controller may determine, based on the sequence identifier included in the second copy of the data frame and based on accepting the first copy of the data frame for further processing, that a data frame that includes the sequence identifier has been previously received by the device, as described above.

As further shown in FIG. 9, process 900 includes rejecting the second copy of the data frame for further processing by the controller based on determining that a data frame that includes the sequence identifier has been previously received by the device (block 960). For example, the controller may reject the second copy of the data frame for further processing by the controller based on determining that a data frame that includes the sequence identifier has been previously received by the device, as described above.

Process 900 may include additional aspects, such as any single aspect or any combination of aspects described below and/or in connection with one or more other processes described elsewhere herein.

In a first aspect, process 900 includes obtaining, via the first asynchronous point-to-point port and from another device, a copy of another data frame; determining that a reset procedure associated with the second asynchronous point-to-point port is active; and accepting the copy of the other data frame for further processing by the controller based on determining that the reset procedure is active.

In a second aspect, alone or in combination with the first aspect, process 900 includes determining that a reset procedure associated with the second asynchronous point-to-point port has completed; obtaining, based on determining that the reset procedure has completed, via the second asynchronous point-to-point port, and from the other device, a copy of a first other data frame that includes another sequence identifier; obtaining, based on determining that the reset procedure has completed, via the first asynchronous point-to-point port, and from the other device, copies of one or more second other data frames that include respective sequence identifiers that do not match the other sequence identifier; and accepting the copies of the one or more second other data frames for further processing by the controller.

In a third aspect, alone or in combination with one or more of the first and second aspects, the copy of the first other data frame is a first copy of the first other data frame, and process 900 includes obtaining, after accepting the copies of the one or more second other data frames for further processing by the controller, via the first asynchronous point-to-point port, and from the other device, a second copy of the first other data frame; accepting a selected one of the first copy of the first other data frame or the second copy of the first other data frame for further processing by the controller; and rejecting a non-selected one of the first copy of the first other data frame or the second copy of the first other data frame for further processing by the controller.

In a fourth aspect, alone or in combination with one or more of the first through third aspects, process 900 includes generating another data frame that includes another sequence identifier, causing a first copy of the other data frame to be transmitted to the other device via the first asynchronous point-to-point port, and causing a second copy of the other data frame to be transmitted to the other device via the second asynchronous point-to-point port.

Although FIG. 9 shows example blocks of process 900, in some implementations, process 900 includes additional blocks, fewer blocks, different blocks, or differently arranged blocks than those depicted in FIG. 9. Additionally, or alternatively, two or more of the blocks of process 900 may be performed in parallel.

The foregoing disclosure provides illustration and description, but is not intended to be exhaustive or to limit the implementations described herein to the precise forms that are described. Modifications and variations can be made in light of the above description or may be acquired from practice of the implementations described herein.

It will be apparent that systems and/or methods described herein can be implemented in different forms of hardware, firmware, or a combination of hardware and software. The actual specialized control hardware or software code used to implement these systems and/or methods is not limiting of the implementations described herein. Thus, the operation and behavior of the systems and/or methods are described herein without reference to specific software code—it being understood that software and hardware can be designed to implement the systems and/or methods based on the description herein.

Even though particular combinations of features are recited in the claims and/or described in the specification, these combinations are not intended to limit the implementations described herein. In fact, many of these features can be combined in ways not specifically recited in the claims and/or described in the specification. For example, the description includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

When “a component” or “one or more components” (or another element, such as “a processor” or “one or more processors”) is described or claimed (within a single claim or across multiple claims) as performing multiple operations or being configured to perform multiple operations, this language is intended to broadly cover a variety of architectures and environments. For example, unless explicitly claimed otherwise (e.g., via the use of “first component” and “second component” or other language that differentiates components in the claims), this language is intended to cover a single component performing or being configured to perform all of the operations, a group of components collectively performing or being configured to perform all of the operations, a first component performing or being configured to perform a first operation and a second component performing or being configured to perform a second operation, or any combination of components performing or being configured to perform the operations. For example, when a claim has the form “one or more components configured to: perform X; perform Y; and perform Z,” that claim should be interpreted to mean “one or more components configured to perform X; one or more (possibly different) components configured to perform Y; and one or more (also possibly different) components configured to perform Z.”

No element, act, or instruction used herein should be construed as critical or essential unless explicitly described as such. Also, as used herein, the articles “a” and “an” are intended to include one or more items, and can be used interchangeably with “one or more.” Further, as used herein, the article “the” is intended to include one or more items referenced in connection with the article “the” and can be used interchangeably with “the one or more.” Furthermore, as used herein, the term “set” is intended to include one or more items (e.g., related items, unrelated items, or a combination of related and unrelated items,), and can be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and can be used interchangeably with “and/or,” unless explicitly stated otherwise (e.g., if used in combination with “either” or “only one of”).

What is claimed is:

1. A communication system, comprising:
a first device that includes a first controller;
a second device that includes a second controller; and
a first asynchronous point-to-point link and a second asynchronous point-to-point link that connect the first device and the second device, wherein:
the first controller is configured to:
generate a data frame that includes a sequence identifier in a header of the data frame;
store a first copy of the data frame in a first transmission data structure of the first device to cause the first copy of the data frame to be transmitted to the second device via the first asynchronous point-to-point link; and
store a second copy of the data frame in a second transmission data structure of the first device to cause the second copy of the data frame to be transmitted to the second device via the second asynchronous point-to-point link.

2. The communication system of claim 1, wherein:
the first asynchronous point-to-point link and the second asynchronous point-to-point link are serial gigabit media independent interface (SGMII) links, and the data frame is an Ethernet frame.

3. The communication system of claim 1, wherein the first copy of the data frame includes the sequence identifier, and
wherein the second controller is configured to:
obtain, after transmission of the first copy of the data frame via the first asynchronous point-to-point link, the first copy of the data frame from a first reception data structure of the second device;
determine, based on identifying the sequence identifier included in the first copy of the data frame, that a data frame that includes the sequence identifier has not been previously received by the second device; and
accept the first copy of the data frame for further processing by the second controller based on determining that a data frame that includes the sequence identifier has not been previously received by the second device.

4. The communication system of claim 1, wherein the second copy of the data frame includes the sequence identifier, and
wherein the second controller is configured to:
obtain, after transmission of the second copy of the data frame via the second asynchronous point-to-point link, the second copy of the data frame from a second reception data structure of the second device;
determine, based on identifying the sequence identifier included in the second copy of the data frame, that a data frame that includes the sequence identifier has been previously received by the second device; and
reject the second copy of the data frame for further processing by the second controller based on determining that a data frame that includes the sequence identifier has been previously received by the second device.

5. The communication system of claim 1, wherein the first controller is further configured to:
generate a first other data frame that includes a first other sequence identifier in a header of the first other data frame;
store a copy of the first other data frame in the first transmission data structure of the first device to cause the first copy of the first other data frame to be transmitted to the second device via the first asynchronous point-to-point link;
determine that a reset procedure associated with the second asynchronous point-to-point link is active; and
prevent, based on determining that the reset procedure is active, storing of a second copy of the first other data frame in the second transmission data structure of the first device.

6. The communication system of claim 5, wherein the first controller is further configured to:
generate a second other data frame that includes a second other sequence identifier in a header of the second other data frame;
store a first copy of the second other data frame in the first transmission data structure of the first device to cause the first copy of the second other data frame to be transmitted to the second device via the first asynchronous point-to-point link;
determine that the reset procedure associated with the second asynchronous point-to-point link has completed; and
store, based on determining that the reset procedure has completed, a second copy of the second other data frame in the second transmission data structure of the first device to cause the first copy of the second other data frame to be transmitted to the second device via the second asynchronous point-to-point link.

7. The communication system of claim 1, wherein the second controller is configured to:
obtain, after transmission of the first copy of the data frame via the first asynchronous point-to-point link, the first copy of the data frame from a first reception data structure of the second device;
determine that a reset procedure associated with the second asynchronous point-to-point link is active; and
accept the first copy of the data frame for further processing by the second controller based on determining that the reset procedure is active.

8. The communication system of claim 7, wherein the second controller is configured to:
determine that the reset procedure associated with the second asynchronous point-to-point link has completed;
obtain, based on determining that the reset procedure has completed, a copy of a first other data frame from a second reception data structure of the second device;
obtain, based on identifying another sequence identifier included in the copy of the first other data frame, copies of one or more second other data frames from the first reception data structure of the second device that include respective sequence identifiers that do not match the other sequence identifier; and
accept the copies of one or more second other data frames for further processing by the second controller.

9. The communication system of claim 8, wherein the copy of the first other data frame is a first copy of the first other data frame, and
wherein the second controller is further configured to:
obtain, after accepting the copies of one or more second other data frames for further processing by the second controller, a second copy of the first other data frame from the first reception data structure of the second device;
accept a selected one of the first copy of the first other data frame or the second copy of the first other data frame for further processing by the second controller; and
reject a non-selected one of the first copy of the first other data frame or the second copy of the first other data frame for further processing by the second controller.

10. The communication system of claim 1, wherein the communication system is one of:
a low Earth orbit satellite,
a medium Earth orbit satellite,
a geostationary orbit satellite, or
a highly elliptical orbit satellite.

11. A device, comprising:
a first asynchronous point-to-point port;
a second asynchronous point-to-point port; and
a controller configured to:
generate a data frame that includes a sequence identifier in a header of the data frame;
cause a first copy of the data frame to be transmitted to another device via the first asynchronous point-to-point port; and
cause a second copy of the data frame to be transmitted to the other device via the second asynchronous point-to-point port.

12. The device of claim 11, wherein the controller is further configured to:
generate a first other data frame that includes a first other sequence identifier in a header of the first other data frame;
cause a copy of the first other data frame to be transmitted to the other device via the first asynchronous point-to-point port;
determine that a reset procedure associated with the second asynchronous point-to-point port is active; and
prevent, based on determining that the reset procedure is active, transmission of a second copy of the first other data frame to the other device via the second asynchronous point-to-point port.

13. The device of claim 12, wherein the controller is further configured to:
generate a second other data frame that includes a second other sequence identifier in a header of the second other data frame;
cause a first copy of the second other data frame to be transmitted to the other device via the first asynchronous point-to-point port;
determine that the reset procedure associated with the second asynchronous point-to-point port has completed; and
cause a second copy of the second other data frame to be transmitted to the other device via the second asynchronous point-to-point port.

14. The device of claim 11, wherein the controller is further configured to:
obtain, via the first asynchronous point-to-point port and from the other device, a copy of another data frame;
determine that a reset procedure associated with the second asynchronous point-to-point port is active; and
accept the copy of the other data frame for further processing by the controller based on determining that the reset procedure is active.

15. The device of claim 11, wherein the controller is further configured to:
determine that a reset procedure associated with the second asynchronous point-to-point port has completed;
obtain, based on determining that the reset procedure has completed, via the second asynchronous point-to-point port, and from the other device, a copy of a first other data frame that includes another sequence identifier;
obtain, based on determining that the reset procedure has completed, via the first asynchronous point-to-point port, and from the other device, copies of one or more second other data frames that include respective sequence identifiers that do not match the other sequence identifier; and
accept the copies of the one or more second other data frames for further processing by the controller.

16. A device, comprising:
a first asynchronous point-to-point port;
a second asynchronous point-to-point port; and
a controller configured to:
obtain, via the first asynchronous point-to-point port and from another device, a first copy of a data frame that includes a sequence identifier;
determine, based on the sequence identifier included in the first copy of the data frame, that a data frame that includes the sequence identifier has not been previously received by the device;
accept the first copy of the data frame for further processing by the controller based on determining that a data frame that includes the sequence identifier has not been previously received by the device;
obtain, via the second asynchronous point-to-point port and from the other device, a second copy of the data frame that includes the sequence identifier;
determine, based on the sequence identifier included in the second copy of the data frame and based on accepting the first copy of the data frame for further processing, that a data frame that includes the sequence identifier has been previously received by the device; and
reject the second copy of the data frame for further processing by the controller based on determining that a data frame that includes the sequence identifier has been previously received by the device.

17. The device of claim 16, wherein the controller is further configured to:
obtain, via the first asynchronous point-to-point port and from another device, a copy of another data frame;
determine that a reset procedure associated with the second asynchronous point-to-point port is active; and
accept the copy of the other data frame for further processing by the controller based on determining that the reset procedure is active.

18. The device of claim 16, wherein the controller is further configured to:
determine that a reset procedure associated with the second asynchronous point-to-point port has completed;
obtain, based on determining that the reset procedure has completed, via the second asynchronous point-to-point port, and from the other device, a copy of a first other data frame that includes another sequence identifier;
obtain, based on determining that the reset procedure has completed, via the first asynchronous point-to-point port, and from the other device, copies of one or more second other data frames that include respective sequence identifiers that do not match the other sequence identifier; and
accept the copies of the one or more second other data frames for further processing by the controller.

19. The device of claim 18, wherein the copy of the first other data frame is a first copy of the first other data frame, and
wherein the controller is further configured to:
obtain, after accepting the copies of the one or more second other data frames for further processing by the controller, via the first asynchronous point-to-point port, and from the other device, a second copy of the first other data frame;
accept a selected one of the first copy of the first other data frame or the second copy of the first other data frame for further processing by the controller; and
reject a non-selected one of the first copy of the first other data frame or the second copy of the first other data frame for further processing by the controller.

20. The device of claim 16, wherein the controller is further configured to:
generate another data frame that includes another sequence identifier;
cause a first copy of the other data frame to be transmitted to the other device via the first asynchronous point-to-point port; and
cause a second copy of the other data frame to be transmitted to the other device via the second asynchronous point-to-point port.
